(19) United States
(12) Patent Application Publication
(10) Pub. No.: US 2011/0157164 A1
(43) Pub. Date: Jun. 30, 2011

(54) IMAGE PROCESSING APPARATUS AND IMAGE PROCESSING METHOD

(75) Inventor: Teruhiko Suzuki, Kanagawa (JP)

(73) Assignee: Sony Corporation, Tokyo (JP)

(21) Appl. No.: 12/972,883

(22) Filed: Dec. 20, 2010

(30) Foreign Application Priority Data
Dec. 28, 2009 (JP) 2009-298453

(51) Int. Cl. G06T 15/00

(52) U.S. Cl. 345/419

(57) ABSTRACT

An image processing apparatus including: a reproduction unit reproducing 3D image data including image data of a right-eye image and a left-eye image in which a predetermined parallax is set; a comparison unit comparing a strength of the parallax set in the 3D image data to be reproduced by the reproduction unit to a strength of a parallax appropriate for ages of viewers obtained from viewer information registered in advance; and a parallax control unit controlling the parallax of the 3D image data reproduced by the reproduction unit according to a strength which is based on the comparison result obtained by the comparison unit.

### BACKGROUND OF THE INVENTION

1. Field of the Invention

The present invention relates to an image processing apparatus and an image processing method, and more particularly, to an image processing apparatus and an image processing method capable of reducing a feeling of fatigue when young viewers watch 3D image data.

2. Description of the Related Art

In recent years, there has been suggested a 3D (3-dimentional) display method as an image display method implemented with an improvement in the number of pixels of a display such as an LCD (Liquid Crystal Display) or an improvement in a frame rate. According to the 3D display method, viewers can recognize a subject stereoscopically. Hereinafter, the images of subjects which viewers can recognize stereoscopically when viewing the images are referred to as 3D images, and image data including data of the 3D image is referred to as 3D image data.

Examples of a method of watching 3D images include a glasses method in which a pair of polarized filter glasses or a pair of shutter glasses is used and a naked-eye method, such as a lenticular method, in which a pair of glasses is not used. A reproduction method of displaying 3D images includes a frame sequential method of alternately displaying left-eye images and right-eye images which have a parallax. By sending the right-eye images and the left-eye images to the right and left eyes of viewers through a pair of shutter glasses or the like, the viewers can experience a stereoscopic feeling.

The characteristics of a 3D image are different from those of a 2D image. Therefore, when viewers watch 3D images for many hours, the viewers may feel further fatigued compared to when viewers watch 2D images. Since viewers experience the 3D images more realistically than the 2D images, the viewers are likely to watch image data for many hours without being conscious of the length of time that has passed.

For example, Japanese Unexamined Patent Application Publication No. 2006-262191 discloses a display apparatus by which a plurality of viewers can individually watch 3D images in appropriate display forms with one stereoscopic image display apparatus.

### SUMMARY OF THE INVENTION

Since viewers watching 3D images sometimes feel fatigued, as described above, in particular, young viewers may feel more strongly fatigued, it is necessary to reduce the feeling of fatigue.

It is desirable to provide a technique capable of reducing a feeling of fatigue when young viewers watch 3D image data.

According to a first embodiment of the invention, there is provided an image processing apparatus including: reproduction means for reproducing 3D image data including image data of a right-eye image and a left-eye image in which a predetermined parallax is set; comparison means for comparing a strength of the parallax set in the 3D image data to be reproduced by the reproduction means to a strength of a parallax appropriate for ages of viewers obtained from viewer information registered in advance; and parallax control means for controlling the parallax of the 3D image data reproduced by the reproduction means according to a strength which is based on the comparison result obtained by the comparison means.

According to the first embodiment of the invention, there is provided an image processing method including the steps of: reproducing 3D image data including image data of a right-eye image and a left-eye image in which a predetermined parallax is set; comparing a strength of the parallax set in the 3D image data to be reproduced to a strength of a parallax appropriate for ages of viewers obtained from viewer information registered in advance; and controlling the parallax of the 3D image data reproduced according to a strength which is based on the comparison result.

According to the first embodiment of the invention, 3D image data including image data of a right-eye image and a left-eye image in which a predetermined parallax is set is reproduced; a strength of the parallax set in the 3D image data to be reproduced is compared to a strength of a parallax appropriate for ages of viewers obtained from viewer information registered in advance; and the reproduced parallax of the 3D image data is controlled according to a strength which is based on the comparison result.

According to a second embodiment of the invention, there is provided an image processing apparatus including:

parallax strength determination means for analyzing 3D image data including image data of a right-eye image and a left-eye image in which a predetermined parallax is set and determining a strength of the parallax of the 3D image data; and transmission means for transmitting the 3D image data, information indicating the strength of the parallax determined by the parallax strength determination means, and information indicating a strength of a parallax appropriate for ages of viewers obtained from viewer information.

According to the second embodiment of the invention, there is provided an image processing method including the steps of: analyzing 3D image data including image data of a right-eye image and a left-eye image in which a predetermined parallax is set and determining a strength of the parallax of the 3D image data; and transmitting the 3D image data, information indicating the determined strength of the parallax, and information indicating a strength of a parallax appropriate for ages of viewers obtained from viewer information.

According to the second embodiment of the invention, analyzing 3D image data including image data of a right-eye image and a left-eye image in which a predetermined parallax is set is analyzed and a strength of the parallax of the 3D image data is determined; and the 3D image data, information indicating the determined strength of the parallax, and information indicating a strength of a parallax appropriate for ages of viewers obtained from viewer information are transmitted.

According to the first and second embodiments of the invention, a feeling of fatigue of young viewers who watch the 3D image data can be reduced.

### BRIEF DESCRIPTION OF THE DRAWINGS

FIG. 1 is a diagram illustrating an exemplary configuration of a 3D image display system according to an embodiment of the invention.

FIG. 2 is a block diagram illustrating an exemplary configuration of a display control apparatus.

FIG. 3 is a block diagram illustrating an exemplary configuration of an encoding device.

FIG. 4 is a flowchart illustrating a process performed by the encoding device.

FIG. 5 is a block diagram illustrating an exemplary configuration of a reproduction processing unit.

FIG. 6 is a diagram illustrating a viewer suitability table.

FIG. 7 is a diagram illustrating a parallax control table.

FIG. 8 is a flowchart illustrating a process performed by the reproduction processing unit.

FIG. 9 is a block diagram illustrating an exemplary configuration of a computer according to an embodiment of the invention.

### DESCRIPTION OF THE PREFERRED EMBODIMENTS

Hereinafter, a preferred embodiment of the invention will be described in detail with reference to the drawings.

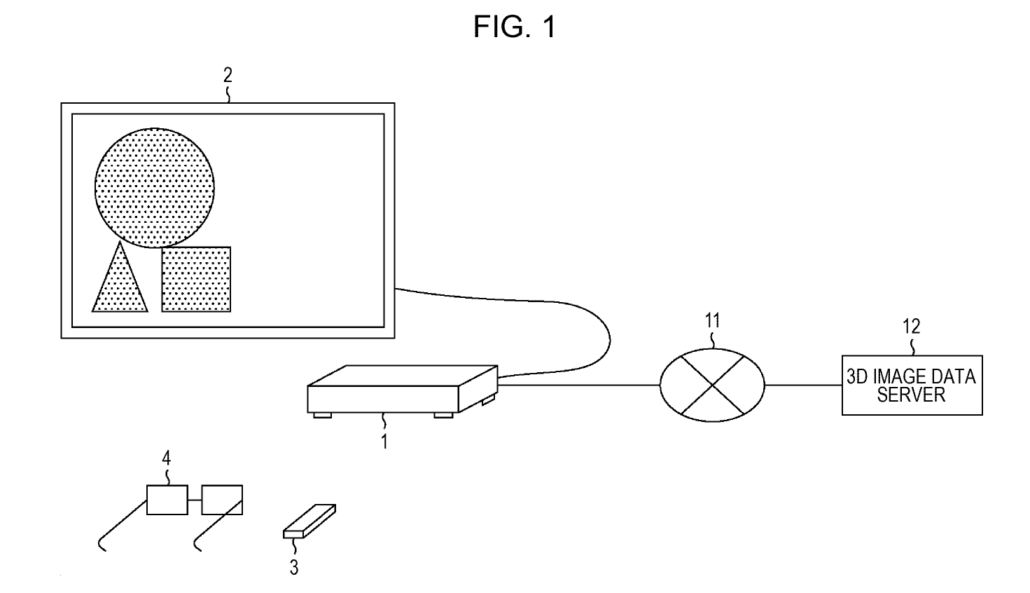

FIG. 1 is a diagram illustrating an exemplary configuration of a 3D image display system according to an embodiment of the invention. In the specification, a system refers to the entire apparatus including a plurality of apparatuses.

The 3D image display system in FIG. 1 includes a display control apparatus 1, a TV (Television receiver) 2, a remote commander 3, and a pair of shutter glasses 4 worn by a user who is a viewer watching image data. That is, a method of watching 3D images by the 3D image display system in FIG. 1 is a method in which a pair of glasses is used. The display control apparatus 1 and the TV 2 are connected to each other by, for example, a cable of the HDMI (High

Definition Multimedia Interface) standard.

A 3D image data server 12 is connected to the display control apparatus 1 via a network 11 configured by the Internet or the like. By communicating between the display control apparatus 1 and the 3D image data server 12 via the network 11, 3D image data stored in the 3D image data server 12 is transmitted to the display control apparatus 1. The 3D image data server 12 is a server which provides 3D image data in response to the request from an apparatus gaining access via the network 11.

A web browser is included in the display control apparatus 1. For example, the display control apparatus 1 displays a selection screen, which is used for lining up and displaying thumbnail images indicating 3D image data which can be watched, on the TV 2 based on data such as an HTML file transmitted from the 3D image data server 12 when gaining access to the 3D image data server 12. The user can give an instruction to receive and reproduce the 3D image data by operating the remote commander 3, operating and moving a cursor displayed on the screen, and designating a thumbnail image.

The 3D image data supplied by the 3D image data server 12 include image data of right-eye images, image data of left-eye images, and additional data. The additional data includes, for example, parallax information as information regarding a parallax between the right-eye image and the left-eye image. The parallax information includes information (1 byte) indicating a 3D strength rank at which the 3D image data is rated according to the strength of the parallax and information (each 1 byte) indicating the maximum and minimum values of a parallax parameter indicating the magnitude of the parallax.

Here, the values of the parallax parameter and the magnitude of the parallax are proportional to each other. Therefore, the parallax between the right-eye image and the left-eye image becomes larger as the value of the parallax parameter gets larger. The user who watches the 3D image data can experience a subject more stereoscopically and thus can feel just as though the subject protrudes out of the TV further. That is, the parallax parameter indicates the degree of the protrusion which is a state when a user views a subject on the 3D image data. The maximum value of the parallax parameter of the parallax information is a value indicating the maximum parallax parameter in the entirety or a predetermined section of the image data. The minimum value of the parallax parameter of the parallax information is a value indicating the minimum parallax parameter in the entirety or a predetermined section of the 3D image data. In addition, the 3D image data also includes voice data reproduced together when the image data is reproduced.

The display control apparatus 1 reproduces the 3D image data transmitted from the 3D image data server 12 and alternately displays the right-eye images and the left-eye images on the TV 2.

A control signal including information regarding a vertical synchronization signal of an image is supplied from the display control apparatus 1 to the pair of shutter glasses 4, for example, by radio communication in which an infrared ray is used. A right-eye transmission section and a left-eye transmission section of the pair of shutter glasses 4 include a liquid crystal device capable of controlling the polarization characteristics. In the pair of shutter glasses 4, two shutter opening and closing operations, i.e., a left-eye open and right-eye close operation and a left-eye close and right-eye open operation, are alternately repeated according to the control signal. As a consequence, only the right-eye images are input into the right eye of the user and only the left-eye images are input into the left eye of the user. The user can experience a stereoscopic subject since the user is alternately viewing the right-eye images and the left-eye images.

Thus, the display control apparatus 1 reproduces the 3D image data transmitted from the 3D image data server 12.

The display control apparatus 1 can register personal information of a user. For example, the user registers his or her personal information by operating the remote commander 3 when purchasing and setting the display control apparatus 1. Since the personal information includes the age of the user or the ages of his or her family, the display control apparatus 1 controls the parallax of the 3D image data depending on the ages of the user's family.

For example, a child has a tendency to feel fatigue more than an adult when watching 3D image data. Therefore, when there is a child in the user's family, that is, when the display control apparatus 1 is used within the environment where the child watches the 3D image data, the display control apparatus 1 controls the parallax so that the strength of the parallax of the 3D image data is reduced depending on the age of the child.

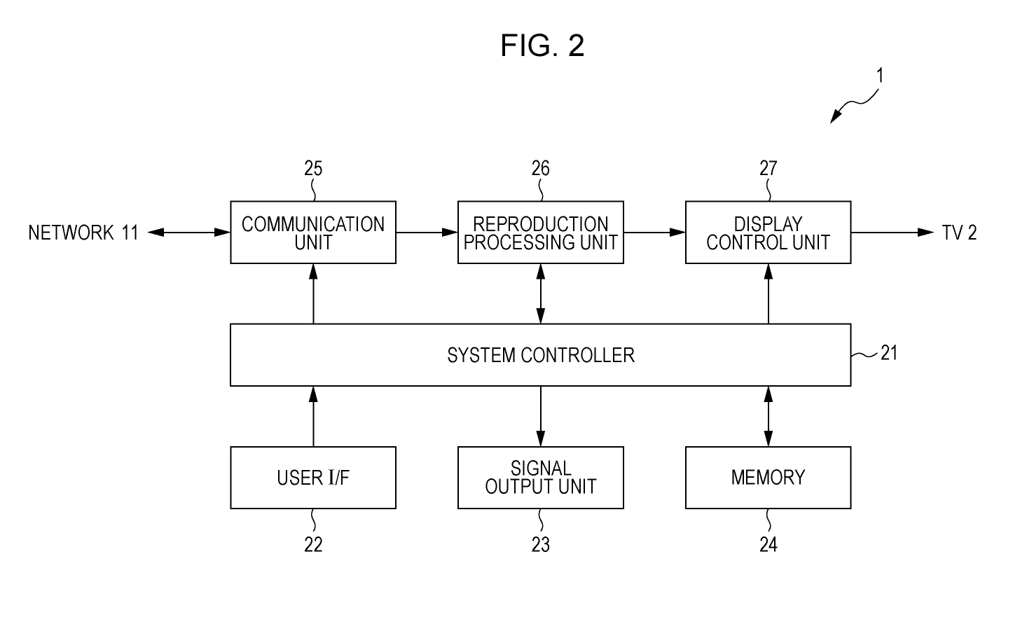

Next, FIG. 2 is a block diagram illustrating an exemplary configuration of the display control apparatus 1.

As shown in FIG. 2, the display control apparatus 1 includes a system controller 21, a user I/F 22, a signal outputting unit 23, a memory 24, a communication unit 25, a reproduction processing unit 26, and a display control unit 27.

The system controller 21 includes a CPU (Central Processing Unit), a ROM (Read-Only Memory), and a RAM (Random Access Memory). The system controller 21 controls the entire operation of the display control apparatus 1 in response to a signal, which indicates the details of the operation of the user, supplied from the user I/F 22. For example, the system controller 21 controls the communication unit 25 to receive the 3D image data transmitted from the 3D image data server 12 and controls the reproduction processing unit 26 to reproduce the 3D image data.

The user I/F 22 detects an operation of the remote commander 3 performed by the user and outputs a signal indicating the details of this operation to the system controller 21.

The signal outputting unit 23 transmits the control signal supplied from the system controller 21 to the pair of shutter glasses 4. In the pair of shutter glasses 4 receiving the control signal transmitted from the signal outputting unit 23, shutter processes of the right-eye transmission section and the left-eye transmission section are controlled.

The memory 24 is a writable memory such as a flash memory (for example, EEPROM (Electronically Erasable and Programmable Read Only Memory)). The memory 24 stores the personal information of the user registered in the display control apparatus 1, various kinds of setting information, or the like.

The communication unit 25 is an interface of the network 11 and communicates with the 3D image data server 12 via the network 11. The communication unit 25 asks the 3D image data server 12 to transmit predetermined 3D image data under the control of the system controller 21, receives the transmitted 3D image data, and outputs the 3D image data to the reproduction processing unit 26.

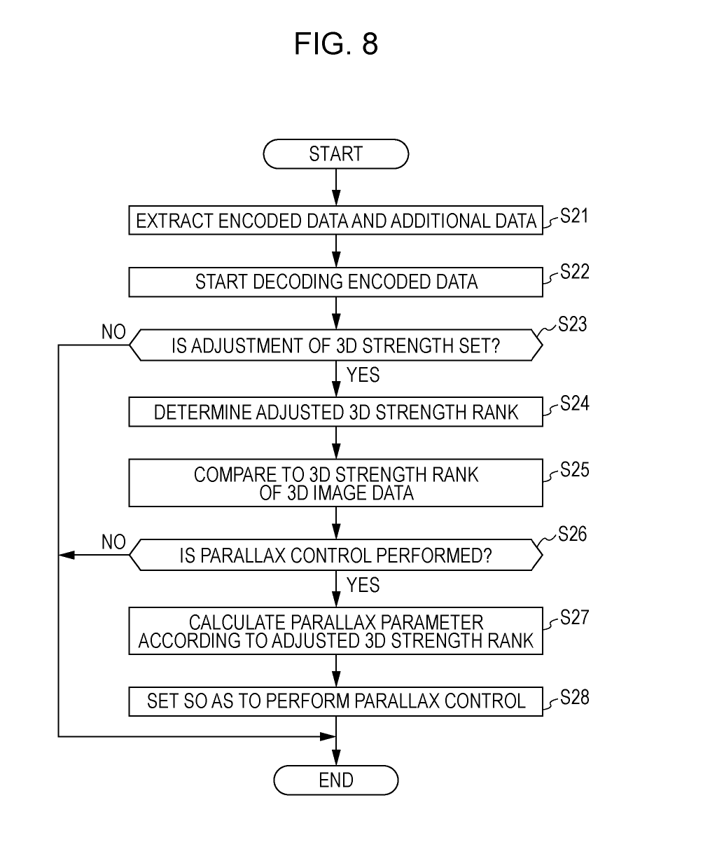

The reproduction processing unit 26 performs reproduction processing, such as a decoding process of decoding compressed data, on the 3D image data, which is to be reproduced, supplied from the communication unit 25. The reproduction processing unit 26 outputs the image data of the right-eye images and the left-eye images obtained by reproducing the 3D image data to the display control unit 27. The reproduction processing unit 26 performs parallax control suitable for the ages of the viewers, as described below with reference to the flowchart of FIG. 8. The voice data used for outputting voices in synchronization with the images of the image data is output from the reproduction processing unit 26 to an external speaker or the like via a circuit (not shown).

The display control unit 27 controls the display of the TV 2 based on the image data of the right-eye images and the left-eye images supplied from the reproduction processing unit 26 and alternately displays the right-eye images and the left-eye images on the TV 2.

In the display control apparatus 1 having the above-described configuration, the 3D image data transmitted from the 3D image data server 12 is received by the communication unit 25 and the reproduction processing is performed by the reproduction processing unit 26. As described above, the 3D image data includes the image data of the right-eye images, the image data of the left-eye images, and the additional data. Therefore, multiplexed data obtained by multiplexing the data is transmitted from the 3D image data server 12.

In the display control apparatus 1, the reproduction processing unit 26 controls the parallax with reference to the information indicating the 3D strength rank included in the additional data extracted from the 3D image data to be reproduced when the 3D strength is higher than the 3D strength suitable for the ages of the viewers, and the 3D image data of which the 3D strength is adjusted (suppressed) is displayed on the TV 2. Here, not only the 3D strength rank of the 3D image data is determined by a producer of the 3D image data, but also the 3D strength rank is determined by the analysis of the 3D image data in the 3D image data server 12, for example.

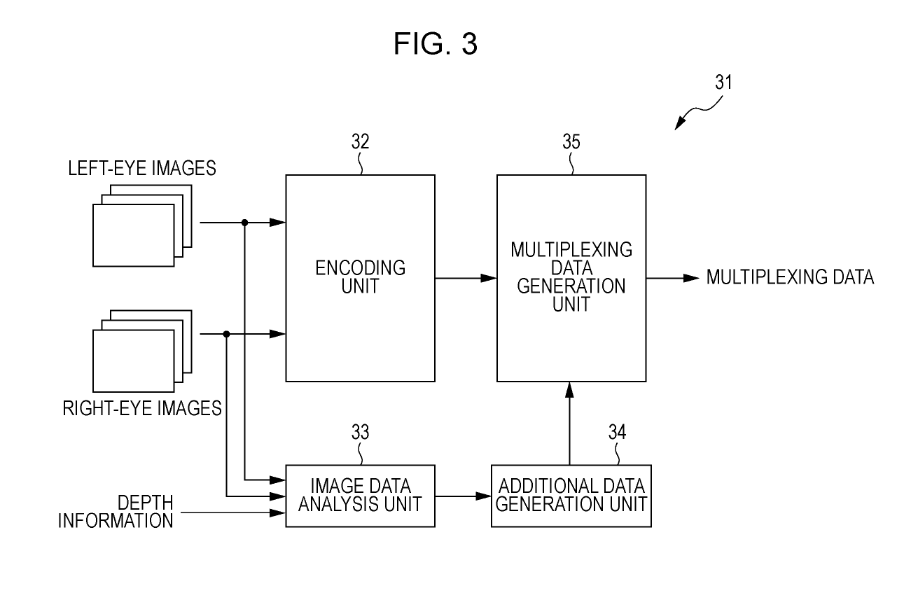

Next, FIG. 3 is a block diagram illustrating an exemplary configuration of an encoding device included in the 3D image data server 12 in FIG. 1.

In FIG. 3, the encoding device 31 includes an encoding unit 32, an image data analysis unit 33, an additional data generation unit 34, and a multiplexed-data generation unit 35.

When the display control apparatus 1 asks the 3D image data server 12 to transmit the 3D image data, the image data of the right-eye images and the left-eye images of the 3D image data are read from a storage device (not shown) and are supplied to the encoding device 31 in the 3D image data server 12. When the 3D image data is generated by computer graphics, the 3D image data includes depth information and thus the depth information is also supplied to the encoding device 31.

The encoding unit 32 encodes the image data of the right-eye images and the left-eye images supplied to the encoding device 31 in conformity with a predetermined encoding scheme such as MPEG-2 or AVC/H.264, and supplies the encoded data of the right-eye images and the left-eye images obtained as the result to the multiplexed-data generation unit 35.

As well as with the encoding unit 32, the image data of the right-eye images and the left-eye images are also supplied to the image data analysis unit 33. The image data analysis unit 33 analyzes the 3D image data based on the image data, calculates the maximum value and the minimum value of the parallax parameter, and supplies the maximum value and the minimum value of the parallax parameter to the additional data generation unit 34.

For example, when the right-eye image is superimposed on the left-eye image, the vector size oriented from a predetermined point of a subject on the right-eye image to the point, which correspond to the predetermined points, of the subject on the left-eye image is used as the parallax parameter. The image data analysis unit 33 calculates the parallax parameter for each image (frame) forming the 3D image data and calculates the maximum value and the minimum value of the parallax parameter in the entire sections or a predetermined section of the 3D image data. When the 3D image data is generated by a computer graphic, the image data analysis unit 33 calculates the maximum value and the minimum value of the parallax parameter using even the depth information of the 3D image data.

The additional data generation unit 34 calculates the 3D strength rank of the 3D image data to be transmitted to the display control apparatus 1 based on the maximum value and the minimum value of the parallax parameter calculated by the image data analysis unit 33. For example, since a plurality of threshold values used for determining the 3D strength rank according to the maximum value and the minimum value of the parallax parameter is set in the additional data generation unit 34, the additional data generation unit 34 calculates the 3D strength rank based on the threshold values.

Then, the additional data generation unit 34 generates the 3D strength rank and the maximum value and the minimum value of the parallax parameter supplied from the image data analysis unit 33 as additional data added to the 3D image data, and supplies the 3D strength rank and the maximum value and the minimum value of the parallax parameter to the multiplexed-data generation unit 35.

The multiplexed-data generation unit 35 generates and outputs multiplexed data by collectively forming the encoded data supplied from the encoding unit 32 and the additional data supplied from the additional data generation unit 34. For example, the parallax information or the like as the additional data may be stored in user data of a video, may define a descriptor of a transport stream (TS) in MPEG-2, or may define a box of MPEG-4. A bit stream including the multiplexed data output from the additional data generation unit 34 is transmitted to the display control apparatus 1 via the network 11 by a communication unit (not shown).

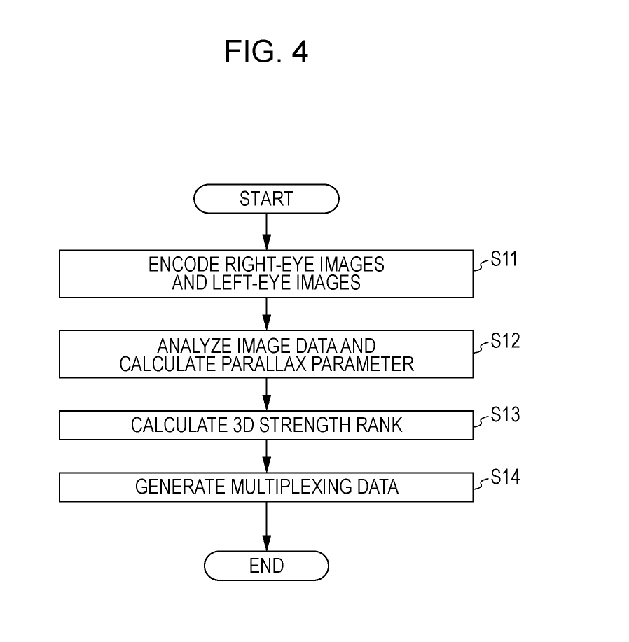

FIG. 4 is a flowchart illustrating a process performed by the encoding device 31 in FIG. 3. When the image data of the right-eye images and the left-eye images of the 3D image data asked to be transmitted by the display control apparatus 1 is supplied to the encoding apparatus 31, the process starts.

In step S11, the encoding unit 32 encodes the image data of the right-eye images and the left-eye images supplied to the encoding device 31 according to a predetermined encoding scheme and supplies the encoded data of the right-eye images and the left-eye images obtained as the result to the multiplexed-data generation unit 35.

In step S12, the image data analysis unit 33 analyzes the image data of the right-eye images and the left-eye images supplied to the encoding device 31, calculates the maximum value and the minimum value of the parallax parameter, and supplies the maximum value and the minimum value of the parallax parameter to the additional data generation unit 34, and then the process proceeds to step S13.

In step S13, the additional data generation unit 34 calculates the 3D strength rank of the 3D image data to be transmitted to the display control apparatus 1 based on the maximum value and the minimum value of the parallax parameter supplied from the image data analysis unit 33 in step S12, and supplies the 3D strength rank of the 3D image data to the multiplexed-data generation unit 35.

In step S14, the multiplexed-data generation unit 35 generates and output the multiplexed data by collectively forming the encoded data supplied from the encoding unit 32 in step S11 and the additional data supplied from the additional data generation unit 34 in step S13. Then, the process ends.

As described above, the encoding device 31 calculates the 3D strength rank by analyzing the 3D image data and outputs the 3D strength rank together with the encoded data. Therefore, the apparatus receiving the 3D image data can easily perform the parallax control process with reference to the 3D strength rank. For example, even when an apparatus with a low processing capability is used as the apparatus receiving the 3D image data, the apparatus receiving the 3D image data can easily perform the parallax control process without analyzing the 3D image data by outputting the 3D strength rank from the encoding device 31.

As described above, the bit stream including the multiplexed data output from the multiplexed-data generation unit 35 is transmitted via the network 11 by the 3D image data server 12 and is received by the display control apparatus 1, and then the multiplexed data included in the bit stream is supplied to the reproduction processing unit 26 via the communication unit 25.

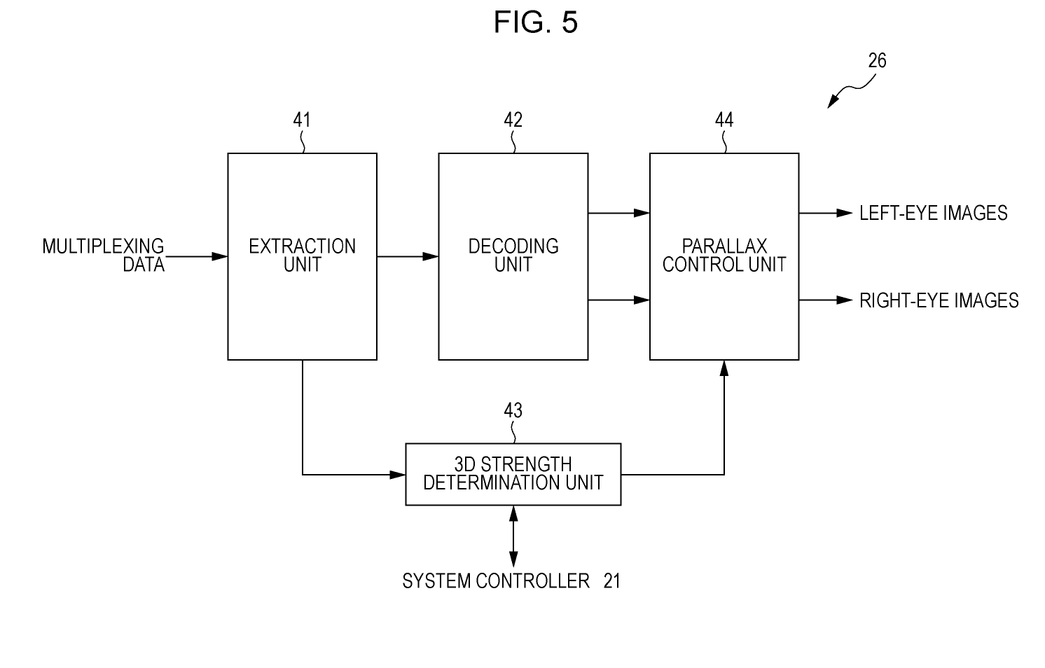

FIG. 5 is a block diagram illustrating an exemplary configuration of the reproduction processing unit 26 in FIG. 2.

As shown in FIG. 5, the reproduction processing unit 26 includes an extraction unit 41, a decoding unit 42, a 3D strength determination unit 43, and a parallax control unit 44.

When the multiplexed data of the 3D image data received by the communication unit 25 in FIG. 2 is supplied to the extraction unit 41, the extraction unit 41 extracts the encoded data and the additional data by dividing the multiplexed data. Then, the extraction unit 41 supplies the encoded data to the decoding unit 42 and supplies the additional data to the 3D strength determination unit 43.

The decoding unit 42 supplies the image data obtained by decoding the encoded data from the extraction unit 41 to the parallax control unit 44. That is, the decoding unit 42 supplies the image data of the right-eye images obtained by decoding the encoded data of the right-eye images to the parallax control unit 44, and also supplies the image data of the left-eye images obtained by decoding the encoded data of the left-eye images to the parallax control unit 44.

Based on the additional data from the extraction unit 41, the 3D strength determination unit 43 determines whether to adjust the 3D strength of the 3D image data when the transmitted 3D image data is reproduced with reference to information stored in the memory 24 via the system controller 21. When adjusting the 3D strength of the 3D image data, the 3D strength determination unit 43 determines the adjusted 3D strength of the 3D image data. Then, the 3D strength determination unit 43 supplies the maximum value and the minimum value of the parallax parameter indicating a range of the parallax parameter equal to or less than the adjusted 3D strength to the parallax control unit 44.

Here, the memory 24 stores setting information indicating various kinds of settings registered for the display control apparatus 1 by the user. For example, the setting information includes information (a flag) indicating whether the 3D strength is adjusted. As described above, the memory 24 stores the personal information (information including the age of the user and the ages of the family) regarding the user. Therefore, the 3D strength determination unit 43 can refer to the setting information and the personal information stored in the memory 24 via the system controller 21.

The 3D strength determination unit 43 stores a viewer suitability table in which the ages of the viewers and the 3D strength ranks set to be suitable for the ages of the viewers are registered by matching each other and a parallax control table in which the maximum values and the minimum values of the parallax parameter matched to the 3D strength ranks are registered. The 3D strength determination unit 43 determines the 3D strength of the adjusted 3D image data based on the setting information and the personal information stored in the memory 24 and the viewer suitability table and the parallax control table, and calculates the maximum values and the minimum values of the parallax parameter.

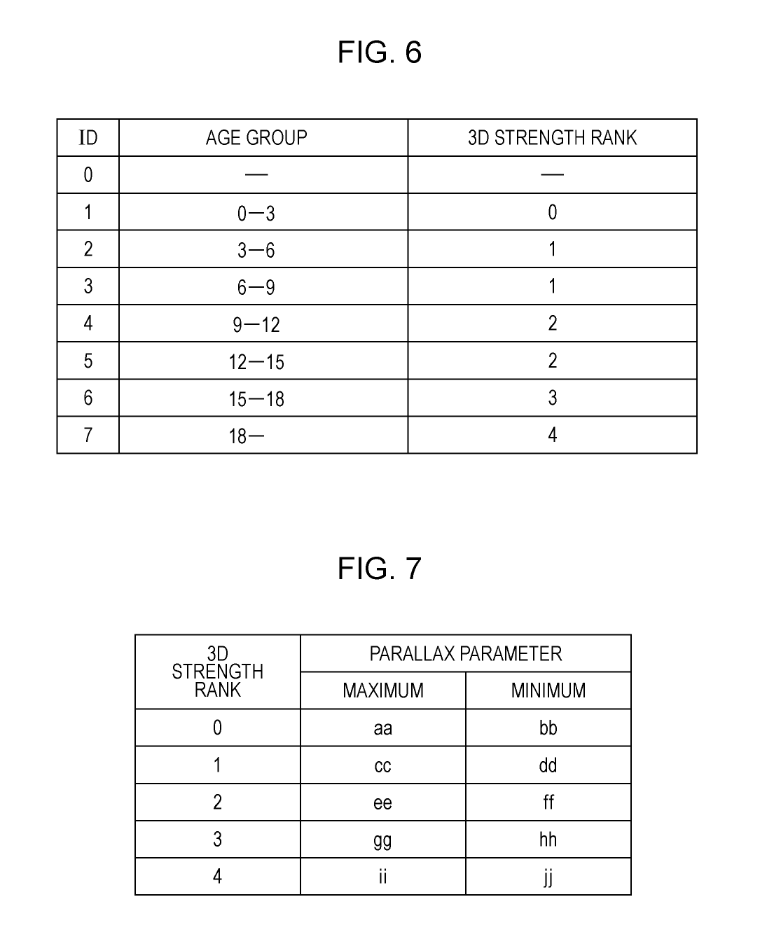

As shown in FIG. 6, the viewer suitability table is a table in which the ages of the viewers and the 3D strength ranks suitable for the ages of the viewers are registered by matching each other. In the viewer suitability table, entry ID0 is a blank entry. In entry ID1, the 3D strength rank of “0” is matched to the “ages over 0 and under 3”. In entry ID2 and entry ID3, the 3D strength rank of “1” is matched to the “ages 3 and over and under 6” and the “ages 6 over and under 9”. In entry ID4 and entry ID5, the 3D strength rank of “2” is matched to the “ages 9 over and under 12” and the “ages 12 over and under 15”. In entry ID6, the 3D strength rank of “3” is matched to the “ages 15 over and under 18”. In entry ID7, the 3D strength rank of “4” is matched to the “ages 18 over”.

As shown in FIG. 7, the parallax control table is a table in which the maximum values and the minimum values of the parallax parameter matched to the 3D strength ranks are registered. In the parallax control table, the maximum value “aa” and the minimum value “bb” of the parallax parameter are matched to the 3D strength rank of “0”, and the maximum value “cc” and the minimum value “dd” of the parallax parameter are matched to the 3D strength rank of “1”. The maximum value “ee” and the minimum value “ff” of the parallax parameter are matched to the 3D strength rank of “2”, and the maximum value “gg” and the minimum value “hh” of the parallax parameter are matched to the 3D strength rank of “3”. The maximum value “ii” and the minimum value “jj” of the parallax parameter are matched to the 3D strength rank of “4”.

When the maximum value and the minimum values of the parallax parameter are supplied from the 3D strength determination unit 43, the parallax control unit 44 performs parallax control on the image data of the right-eye images and the left-eye images supplied from the decoding unit 42 according to the range of the parallax parameter, and adjusts the 3D strength of the 3D image data. When the parallax between the right-eye image and the left-eye image is equal to or larger than the maximum value of the parallax parameter, the parallax control unit 44 performs the control so that the parallax between the right-eye image and the left-eye image falls within the range of the parallax parameter from the 3D strength determination unit 43, for example, by offsetting the left-eye image so that the position of a subject in the left-eye image when the right-eye image is superimposed on the left-eye image approaches a subject on the right-eye image. The image data of the right-eye images and the left-eye images of the 3D image data of which the parallax is adjusted are output from the parallax control unit 44.

In the reproduction processing unit 26, the 3D strength of the 3D image data being reproduced is determined by the 3D strength determination unit 43, and the 3D image data of which the 3D strength is adjusted to be equal to or less than the determined 3D strength by the parallax control unit 44 is output.

FIG. 8 is a flowchart illustrating the parallax control process performed by the reproduction processing unit 26 in FIG. 5.

For example, when the multiplexed data of the 3D image data transmitted from the 3D image data server 12 is supplied to the reproduction processing unit 26, the process starts. In step S21, the extraction unit 41 extracts the encoded data and the additional data from the multiplexed data. The extraction unit 41 supplies the encoded data to the decoding unit 42 and also supplies the additional data to the 3D strength determination unit 43. Then, the process proceeds to step S22.

In step S22, the decoding unit 42 starts decoding the encoded data supplied from the extraction unit 41, and sequentially supplies the image data of the right-eye images and the left-eye images obtained through the decoding to the parallax control unit 44.

In step S23, the 3D strength determination unit 43 determines whether the adjustment of the 3D strength is set with reference to the setting information (information indicating whether the adjustment of the 3D strength is performed) stored in the memory 24 via the system controller 21.

For example, when the ages under 18 are not registered in the personal information, initial setting is performed in the display control apparatus 1 so that the setting information stored in the memory 24 indicates that the adjustment of the 3D strength is not performed. On the other hand, when the ages under 18 are registered in the personal information, initial setting is performed in the display control apparatus 1 so that the setting information stored in the memory 24 indicates that the adjustment of the 3D strength is performed. For example, since a button operated when viewers are adults is installed in the remote commander 3, a user can operate the button to change the setting so that the setting information stored in the memory 24 indicates that the adjustment of the 3D strength is not performed.

When the 3D strength determination unit 43 determines that the adjustment of the 3D strength is set in step S23, the process proceeds to step S24. In step S24, referring to the viewer suitability table (see FIG. 6), the 3D strength determination unit 43 determines the 3D strength rank matched to the ages of the youngest users in the personal information stored in the memory 24, as the 3D strength to be applied to the 3D image data after the adjustment of the 3D strength.

After step S24, the process proceeds to step S25. Then, the 3D strength determination unit 43 compares the 3D strength rank determined in step S24 to the 3D strength rank included in the additional data supplied from the extraction unit 41 in step S21, and then the process proceeds to step S26.

In step S26, the 3D strength determination unit 43 determines whether the parallax control is performed based on the comparison result of step S25. For example, when the 3D strength rank determined in step S24 is less than the 3D strength rank of the additional data supplied in step S21, the 3D strength determination unit 43 determines that the parallax control is performed. On the other hand, when the 3D strength rank determined in step S24 is not less than the 3D strength rank of the additional data supplied in step S21, the 3D strength determination unit 43 determines that the parallax control is not performed.

When the 3D strength determination unit 43 determines that the parallax control is performed in step S26, the process proceeds to step S27. The 3D strength determination unit 43 calculates the maximum value and the minimum value of the parallax parameter matched to the 3D strength rank determined in step S24 with reference to the parallax control table (see FIG. 7), and supplies the maximum value and the minimum value of the parallax parameter to the parallax control unit 44.

After step S27, the process proceeds to step S28. Then, the parallax control unit 44 performs setting so that the parallax strength of the 3D image data based on the image data of the right-eye images and the left-eye images supplied from the decoding unit 42 falls within the range of the maximum value and the minimum value of the parallax parameter supplied from the 3D strength determination unit 43. In addition, the parallax control unit 44 starts the parallax control according to this setting, and then the process ends.

When the 3D strength determination unit 43 determines that the adjustment of the 3D strength is not set in step S23 or when the 3D strength determination unit 43 determines that the parallax control is not performed in step S26, the parallax control by the parallax control unit 44 is not performed and the process ends. For example, when the 3D strength determination unit 43 determines that the parallax control is not performed in step S26, the 3D image data is reproduced at the 3D strength lower than the 3D strength rank for the ages of the viewers even though the 3D image data is reproduced according to the 3D strength rank of the 3D image data to be reproduced. Therefore, it is not necessary to perform the adjustment of the 3D strength.

In this way, in the reproduction processing unit 26, the 3D strength of the 3D image data is adjusted according to the 3D strength rank for the viewers of the youngest age. Therefore, a feeling of fatigue of the young viewers watching the 3D image data can be reduced.

For example, the reproduction processing unit 26 not only performs the same parallax control through the entirety of the 3D image data, but also may perform the parallax control in a predetermined section of the 3D image data. For example, the reproduction processing unit 26 detects whether sections of the 3D image data in which the parallax is large are continuous. When the sections of the 3D image data in which the parallax is large are continuous, the reproduction processing unit 26 can reduce the 3D strength rank applied to the 3D image data being reproduced. That is, the feeling of fatigue is generally increased, when viewers keeps watching the 3D image data in which the parallax is large for many hours. Therefore, by weakening the parallax when the sections in which the parallax is large are continuous, the feeling of fatigue of the viewers can be reduced.

The 3D image data is analyzed and 3D strength rank is determined in the 3D image data server 12. Moreover, when the display control apparatus 1 has a high performance, the 3D image data may be analyzed and the 3D strength rank may be determined in the display control apparatus 1, and then it may be determined whether the parallax control is performed. Thus, when the 3D image data is analyzed in the display control apparatus 1, for example, a timing at which scenes of the 3D image data are changed (scene changing) is detected. When there is a child among the viewers, the parallax control of weakening the parallax before and after the scene changing can be performed. Thus, the feeling of fatigue of the viewers caused due to the change in the parallax before and after the scene changing can be suppressed.

Even when the personal information is not registered in the display control apparatus 1, the user can operate the remote commander 3 so that the 3D strength is adjusted in the reproduction processing unit 26 when there is a child among the viewers. In this case, for example, a button (or a button operated in a case where there are only adults) operated when there is a child may be installed in the remote commander 3.

In this embodiment, the example has hitherto been described in which the 3D image data is transmitted from the 3D image data server 12 via the network 11. However, for example, the 3D image data may be supplied from in a disk storing the 3D image data. Alternatively, the 3D image data may be supplied by broadcast using broadcast waves. In this case, the display control apparatus 1 can acquire the 3D image data by driving a disk drive or can acquire the 3D image data via a reception apparatus receiving the broadcast waves.

The embodiment of the invention is applicable not only to an image processing apparatus which performs processing on 3D image data formed by two images (so-called stereo image) of a right-eye image and a left-eye image, but also, for example, to an image processing apparatus which performs processing on 3D image data formed by multi-view images including three or more images, i.e., a plurality of images. That is, the above-described process is applicable to parallax control on two images by which a subject is viewed stereoscopically from a direction in which a user is located, among multi-view images including a plurality of images. The above-described series of processes (image processing method) may be executed by hardware or software. When the series of processes are executed by software, a program forming the software is installed in a computer embedded with dedicated hardware or a computer such as a general personal computer, which is capable of installing various programs and executing various functions, from a program recording medium in which a program is recorded.

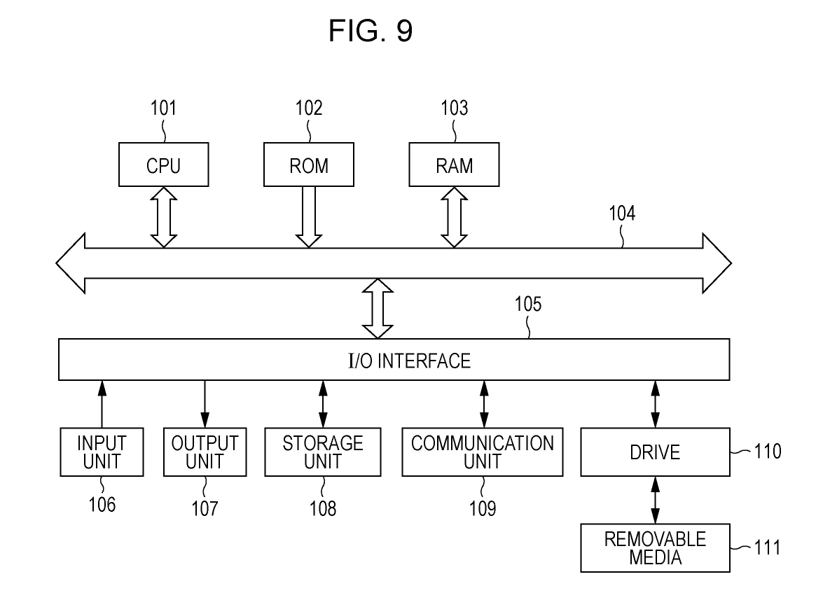

FIG. 9 is a block diagram illustrating an exemplary hardware configuration of a computer executing the above-described series of processes by a program.

In the computer, a CPU (Central Processing Unit) 101, a ROM (Read-Only Memory) 102, and a RAM (Random Access Memory) 103 are connected to each other via a bus 104.

An I/O interface 105 is connected to the bus 104. An input unit 106 configured by a keyboard, a mouse, a microphone, and the like, an output unit 107 configured by a display, a speaker, and the like, a storage unit 108 configured by a hard disk, a non-volatile memory, and the like, a communication unit 109 configured by a network interface or the like, and a drive 110 driving a removable media 111 such as a magnetic disk, an optical disk, a magneto-optical disk, or a semiconductor memory are connected to the I/O interface 105.

In the computer having such a configuration, the CPU 101 loads and executes, for example, a program stored in the storage unit 108 on the RAM 103 via the I/O interface 105 and the bus 104 to perform the above-described series of processes.

The program executed by the computer (CPU 101) is recorded in the removable media 111 which is a package media configured by a magnetic disk (including a flexible disk), an optical disk (CD-ROM (Compact Disc-Read Only Memory), DVD (Digital Versatile Disc), and the like), a magneto-optical disk, a semiconductor memory, or the like. Alternatively, the program is provided via a wired or wireless transmission media such as a local area network, the Internet, or digital satellite broadcasting.

The program may be installed to the storage unit 108 via the I/O interface 105 by mounting the removable media 111 on the drive 110. The program may be received via a wired or wireless transmission medium through the communication unit 109 and may be installed in the storage unit 108. Alternatively, the program may be installed in advance to the ROM 102 and the storage unit 108.

The program executed by the computer may be a program performing the process chronologically in the order described in the specification or may be a program performing the process, for example, at a necessary timing, in response to a call or in parallel.

The present application contains subject matter related to that disclosed in Japanese Priority Patent Application JP 2009-298453 filed in the Japan Patent Office on Dec. 28, 2009, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An image processing apparatus comprising:
reproduction means for reproducing 3D image data including image data of a right-eye image and a left-eye image in which a predetermined parallax is set;
comparison means for comparing a strength of the parallax set in the 3D image data to be reproduced by the reproduction means to a strength of a parallax appropriate for ages of viewers obtained from viewer information registered in advance; and
parallax control means for controlling the parallax of the 3D image data reproduced by the reproduction means according to a strength which is based on the comparison result obtained by the comparison means.

2. The image processing apparatus according to claim 1, wherein when the strength of the parallax appropriate for the ages of the viewers obtained from the viewer information registered in advance is lower than the strength of the parallax set in the 3D image data to be reproduced by the reproduction means, the parallax control means controls the parallax of the 3D image data so as to be equal to or lower than the strength of the parallax appropriate for the ages of the viewers.

3. The image processing apparatus according to claim 1,
wherein referring to a parallax control table in which the strength of the parallax is matched to a parallax parameter indicating a magnitude of the parallax controlled by the parallax control means, the comparison means obtains the parallax parameter matched to the strength of the parallax appropriate for the ages of the viewers as the comparison result, and
wherein the parallax control means controls the parallax of the 3D image data according to the parallax parameter obtained by the comparison means.

4. The image processing apparatus according to claim 3,
wherein in the parallax control table, the strengths of the parallax are matched to maximum values and minimum values of the parallax parameter, and
wherein the parallax control means controls the parallax of the 3D image data so as to fall within a range between the maximum value and the minimum value of the parallax parameter obtained by the comparison means.

5. An image processing method comprising the steps of:
reproducing 3D image data including image data of a right-eye image and a left-eye image in which a predetermined parallax is set;
comparing a strength of the parallax set in the 3D image data to be reproduced to a strength of a parallax appropriate for ages of viewers obtained from viewer information registered in advance; and
controlling the parallax of the 3D image data reproduced according to a strength which is based on the comparison result.

6. An image processing apparatus comprising:
parallax strength determination means for analyzing 3D image data including image data of a right-eye image and a left-eye image in which a predetermined parallax is set and determining a strength of the parallax of the 3D image data; and
transmission means for transmitting the 3D image data, information indicating the strength of the parallax determined by the parallax strength determination means, and information indicating a strength of a parallax appropriate for ages of viewers obtained from viewer information.

7. An image processing method comprising the steps of:
analyzing 3D image data including image data of a right-eye image and a left-eye image in which a predetermined parallax is set and determining a strength of the parallax of the 3D image data; and
transmitting the 3D image data, information indicating the determined strength of the parallax, and information indicating a strength of a parallax appropriate for ages of viewers obtained from viewer information.

8. An image processing apparatus comprising:
a reproduction unit reproducing 3D image data including image data of a right-eye image and a left-eye image in which a predetermined parallax is set;
a comparison unit comparing a strength of the parallax set in the 3D image data to be reproduced by the reproduction unit to a strength of a parallax appropriate for ages of viewers obtained from viewer information registered in advance; and
a parallax control unit controlling the parallax of the 3D image data reproduced by the reproduction unit according to a strength which is based on the comparison result obtained by the comparison unit.

9. An image processing apparatus comprising:
a parallax strength determination unit analyzing 3D image data including image data of a right-eye image and a left-eye image in which a predetermined parallax is set and determining a strength of the parallax of the 3D image data; and
a transmission unit transmitting the 3D image data, information indicating the strength of the parallax determined by the parallax strength determination unit, and information indicating a strength of a parallax appropriate for ages of viewers obtained from viewer information.
